(19) United States
(12) Patent Application Publication
(10) Pub. No.: US 2018/0173681 A1
(43) Pub. Date: Jun. 21, 2018

(54) SYSTEM AND METHOD FOR GENERATING CONTENT PERTAINING TO REAL PROPERTY ASSETS

(71) Applicant: Ten-X, LLC, Irvine, CA (US)

(72) Inventors: Harshal Dedhia, Irvine, CA (US); Geoffrey Sterling Ryder, Irvine, CA (US); Nicholas Dearden, Irvine, CA (US); Lisa Panda, Irvine, CA (US); Brenda Kao, Irvine, CA (US)

(21) Appl. No.: 15/387,483

(22) Filed: Dec. 21, 2016

(51) Int. Cl. G06F 17/21; G06F 17/30; G06Q 50/16; G06F 17/27; G06K 9/00; G06T 7/00; G06T 7/60; G06T 7/73

(52) U.S. Cl. CPC G06F 17/218; G06F 17/30011; G06Q 50/16; G06F 17/2705; G06T 2207/30108; G06T 7/0012; G06T 7/60; G06T 7/73; G06F 17/30268; G06K 9/00456

(57) ABSTRACT

A real property document processing system can parse real property documents such as appraisal documents to extract useful information relating to real property assets. The system can extract images, text, and other information. Using the extracted information, the system can associate extracted images with portions of text as corresponding captions. Caption association can be performed based on results of directional analyses performed on each page of the real property document. In addition, caption associate can be performed based on results of context analyses—the system can determine appropriate captions by comparing the text of caption candidates against known keywords associated with contexts determined for the images. By analyzing the images and their associated captions, the system can detect one or more real property features depicted in each of the images. The real property features can be used to assign searchable tags to the images.

### BACKGROUND

With the rise of Internet and Internet-commerce, real property asset transactions increasingly depend on the Internet. For example, potential buyers usually rely on information presented on electronic or online media (e.g. websites or web pages) in researching real property assets. In other cases, real estate transactions are completed, in part or in whole, over the Internet. Thus, generating content (e.g., webpages, websites, etc.) pertaining to real property assets that contain accurate and consistent information is of critical importance.

In addition, a large number of real property documents are generated (e.g., appraisal documents, broker price opinion documents, photograph addendums, home inspection documents, etc.) in real estate transactions. These documents contain valuable information for the generation of content pertaining to real property assets, including images of the real property assets. However, parsing and extracting relevant information and images from these documents is especially time-consuming and tedious. Operators often have to review the real property documents and manually extract relevant information or images for the generation of content pertaining to real property assets.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example real property document processing system for parsing real property documents and generating content pertaining to real property assets for presentation to users over an electronic medium, in accordance with examples described herein;

FIG. 2 is a flow chart describing an example method for parsing real property documents, in accordance with examples described herein;

FIG. 3 is a flow chart describing an example method of associating extracted images with caption text, in accordance with examples described herein;

FIGS. 4A and 4B are figures illustrating layouts of sample real property documents that can be parsed and analyzed by an example real property document processing system, in accordance with examples described herein; and

FIG. 5 is a block diagram illustrating a computer system upon which examples described herein may be implemented.

### DETAILED DESCRIPTION

Embodiments described herein provide for a real property document processing system (“RPDPS”) capable of extracting, processing, and analyzing features and information (e.g., images, text, layout information, metadata information, etc.) from real property documents (e.g., appraisal reports, inspection reports, title search reports etc.). Based on the analysis and processing of the features and other information extracted from the real property documents, the RPDPS can programmatically categorize and assign tags to images extracted from the documents based on features recognized in the images or other information associated with the images. Images, text, and other information extracted from the real property documents can be used to generate content (e.g., websites, webpages, and/or interactive content) pertaining to the one or more real property assets. The generated content can be presented to various users of the system (e.g., agents, sellers, or potential buyers of real asset properties) over a network (e.g., the Internet).

In various examples, the RPDPS receives real property documents from various sources, such as third party document repositories or publicly available databases. The RPDPS is configured to parse the documents to identify and extract features (e.g., images, text, etc.) depicted in the real property documents for further processing. The RPDPS can also extract additional information from the real property documents, including layout information pertaining to the images and text depicted in the documents. The layout information can include information regarding one or more of the following: orientations (e.g., portrait, landscape, etc.) of the features depicted in the documents, the spatial relationships (e.g., above, below, right, or left) between each of the features, the respective positions of each of the features on the pages of the documents, etc.

According to embodiments, the RPDPS is configured to analyze extracted images and text to associate portions of extracted text with individual images as captions. By associating captions with images, the system can leverage the information contained in the captions to, for example, identify real property features depicted in the images (e.g., attached garage, Spanish-style roof, etc.). The RPDPS can also leverage the information contained in the captions to determine which of the images in a real property document are relevant (e.g., images that pertain to a subject property of the real property document as opposed to other images that pertain to comparable properties). In various implementations, the RPDPS first identifies portions of text as caption candidates for the images based on layout information. For each image depicted in a document, the RPDPS can identify one or more portions of text as caption candidates based on the respective spatial relationships of the portions of text with respect to each of the images. For example, for a specific image depicted in a document, the RPDPS can identify all portions of text located immediately adjacent to the specific image as caption candidates for the specific image. As another example, the RPDPS can identify all portions of text located within a certain distance of the specific image as caption candidates for the specific image.

The RPDPS can associate images with their respective caption candidates based on one or more analyses of the images, the caption candidates, and/or their positions and orientations in relation to each other. In the examples described herein, the RPDPS can perform directional analysis as part of the analysis to associate images with their corresponding captions. The directional analysis can yield directional metrics that indicates a weight to attribute to caption candidates in each direction (e.g., up, down, right, and left) of images in associating the images with an appropriate one of the caption candidate as image captions. Directional metrics can be determined on a per-page basis or a per document basis. A directional metric corresponding to a particular direction (e.g., up) can be determined based on a total number of caption candidates that are depicted in that direction of their associated images on a particular page or in a particular real property document. Based on the directional metrics, the RPDPS can associate images with appropriate caption candidates. For instance, if on a particular page or within a particular document, the highest directional metric pertains to the direction “down,” the RPDPS can determine each caption candidate depicted below their respective associated images as the appropriate captions for those images. In some examples, the RPDPS can combine directional metrics with other analyses in associating images with appropriate caption candidates.

According to embodiments, the RPDPS can determine other metrics pertaining to the caption candidates such as a context metric. A context metric for a caption candidate with respect to an image can be determined by first determining a context for the image and then by identifying text in the caption candidate that matches a list of known keywords associated with the identified context. In various implementations, the RPDPS can be configured to determine a number of different contexts for the images. In one example, the RPDPS can determine one of two possible contexts for the images: Exterior—corresponding to images depicting the exterior of a real property asset (e.g., front of the property, back yard, driveway, roof, etc.) and Interior—corresponding to images depicting areas inside the real property asset (e.g., living room, dining room, bathroom, etc.). In other examples, the RPDPS can determine a number of contexts each representing a portion of the real property asset being depicted. For instance, the RPDPS can determine contexts such as Front Yard, Back Yard, Garage, Living Room, Bathroom, Basement, Stairs, etc.

In certain implementations, the RPDPS performs context analysis to determine contexts for images. Context analysis can include extracting colors to obtain a color palette or color histogram of each image and/or extracting texture features from each image. The results of the context analysis can be compared against model or sample results in a library to determine an appropriate context (e.g., the most likely context based on the comparison) for each image analyzed. For instance, the library can contain model or sample results for each of the available contexts. In one example in which available contexts are Interior and Exterior, the library can include a set of model or sample results corresponding to the Interior context and another set of model or sample results corresponding to the Exterior context. The RPDPS can compare the results of context analysis (e.g., color extraction, texture feature extraction, etc.) with the model or sample results in the library to determine and associate an appropriate context with the corresponding image.

In various examples, the determined context of an image can be used in associating the appropriate caption candidate with the image. Information (e.g., text) in the caption candidates for the image can be compared with known keywords associated with the determined context. For instance, text from a caption candidate can be recognized (e.g., through optical character recognition) and the recognized text can be compared against a set of known keywords associated with the determined context for the image. As an example, keywords such as “yard,” “porch,” and “roof” can be associated with the Exterior context. Similarly, keywords such as “living room,” “bedroom,” and “bathroom” can be associated with the Interior context. In this manner, the RPDPS can determine a context metric for each caption candidate of an image. The context metric can be determined based on a number of words matched with the list of known keywords associated with the determined context. The context metric can also be based on the strength of the matches. For instance, known keywords associated with a context can be categorized based on relative strength and the context metric can be based on which of the categories of keywords is matched with text in the caption candidate. Using context analysis, the RPDPS can determine whether a particular one of the caption candidates image is likely to be an appropriate caption for the image based on information identified in the image (e.g., context information) and information identified in the caption candidate (e.g., text).

According to embodiments, the RPDPS can combine the results of directional analysis (e.g., directional metrics) with the results of context analysis (e.g., context metrics) to arrive at a combined metric that can be used to determine the appropriate caption candidates to associate with images as the images' respective captions. The combined metric can be weighted and the RPDPS can determine the relative weight to attribute to the directional analysis as compared with the context analysis. For instance, the RPDPS can attribute more weight to the directional metrics as compared with the context metrics, or vice versa. In some examples, the relative weight of directional metrics and context metrics can be pre-determined. In other examples, the relative weight can be determined dynamically by the RPDPS.

Once the RPDPS has associated caption candidates to images as captions, the RPDPS can parse the captions to recognize keywords to gather additional information regarding the images. For instance, the RPDPS can parse a caption to determine whether the corresponding image depicts a comparable property or the subject property. As an example, the RPDPS can parse the caption and recognize a keyword such as “Similar Property” or “Comparable” to determine that the corresponding image depicts a comparable property rather than the subject property.

In the examples described herein, the RPDPS can determine and assign one or more tags to each of the images based on features recognized in the images. A tag can be indicative of a portion of the subject property depicted in an image (e.g., porch, living room, garage, etc.). Other examples of tags can be indicative of features of the subject property depicted or visible in the images (e.g., swimming pool, white picket fence, attached garage, etc.). Tags can also include those indicative of an architectural style of the subject property discernable from the images (e.g., Spanish roof, colonial, modern, etc.). Other tags can indicate a condition of the subject property visible in the images (e.g., mold, boarded up windows, clean, etc.). The RPDPS can determine tag(s) for an image by performing image analysis (e.g., image feature recognition). The RPDPS can further determine tag(s) for the image by analyzing the caption associated with the image. Furthermore, the RPDPS can determine tag(s) for the image using context information associated with the image. In certain implementations, the RPDPS also can determine a property condition score representative of the condition of the subject property determined using the extracted images, their associated captions, and other textual information extracted from the real property documents. The property condition score can be a numeric value or one of a plurality of qualitative descriptions (e.g., flawless, excellent, average, below average, etc.).

In some examples, the RPDPS can generate content pertaining to the subject property using information extracted from the real property documents, including images, text, and other information. Generated content can include webpages, websites, videos, or interactive content, such as real property asset listing webpages, real property asset auction webpages, and the like. Generated content can be transmitted to users or customers over a network such as the Internet. Content generation can include selecting and/or sequencing appropriate images based on their respective context information or tag(s). The programmatic generation of content can provide a predictable and consistent user experience when viewing the content generated in this manner. For instance, images can be sequenced in a consistent order among various real property auction webpages such that the real property auction webpages maintain a consistent appearance to users. In some examples, content can be generated by a real property document processing system communicatively coupled to the RPDPS. In some examples, the generated content can be searchable using tags or property condition scores. For instance, a search using a tag (e.g., white picket fence) of real property asset auction webpages generated in the manner described herein can yield all webpages that includes one or more images being associated with the tag (e.g., auction webpages including at least one image having the white picket fence tag).

Among other benefits, examples recognize that programmatic extraction of images and other information from real property documents can vastly reduce the amount of time needed to process real property documents to gather content data selection of content can reduce required user or administrator input in generating the content. With an increasing percentage of real property asset transactions being advertised or completed on the Internet, a large amount of content pertaining to real property assets must be generated. The reduction in required user or administrator input in generating the content can lead to a significant streamlining of the process to list, advertise, auction, and/or sell the real property assets. Furthermore, embodiments described herein recognize that it can be beneficial for users to be able to search for specific aspects of images of real property assets shown in content such as auction webpages. As such, embodiments provide for the determination of searchable criteria, such as tags or context information, for images of real property assets extracted from real property documents. Additionally, embodiments recognize that potential buyers researching, viewing, buying, or bidding on real property assets on the Internet can interact with a large number of real property asset listings in a short period of time. Accordingly, it can be beneficial to present a consistent user experience to such potential buyers.

As described herein, a “subject property” can be a real property asset for which content is being generated by the system. In the context of an appraisal report, for example, the subject property can be a real property asset being valued or appraised in an appraisal document. Typically, such documents contain information regarding both the subject property and comparable properties. In the context of an inspection report, the subject property can be a real property asset that is the subject of an inspection. A “user” of the system can be a potential buyer of real property assets who interacts with or views content pertaining to the real property assets generated by the system. Users can interact with content generated by the system by, for example, placing bids on real property assets or submitting inquiries regarding the real property assets. Other users can include sellers of real property assets or agents.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, laptop computers, printers, digital picture frames, network equipments (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments described herein can be carried and/or executed. In particular, the numerous machines shown with examples described herein include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Description

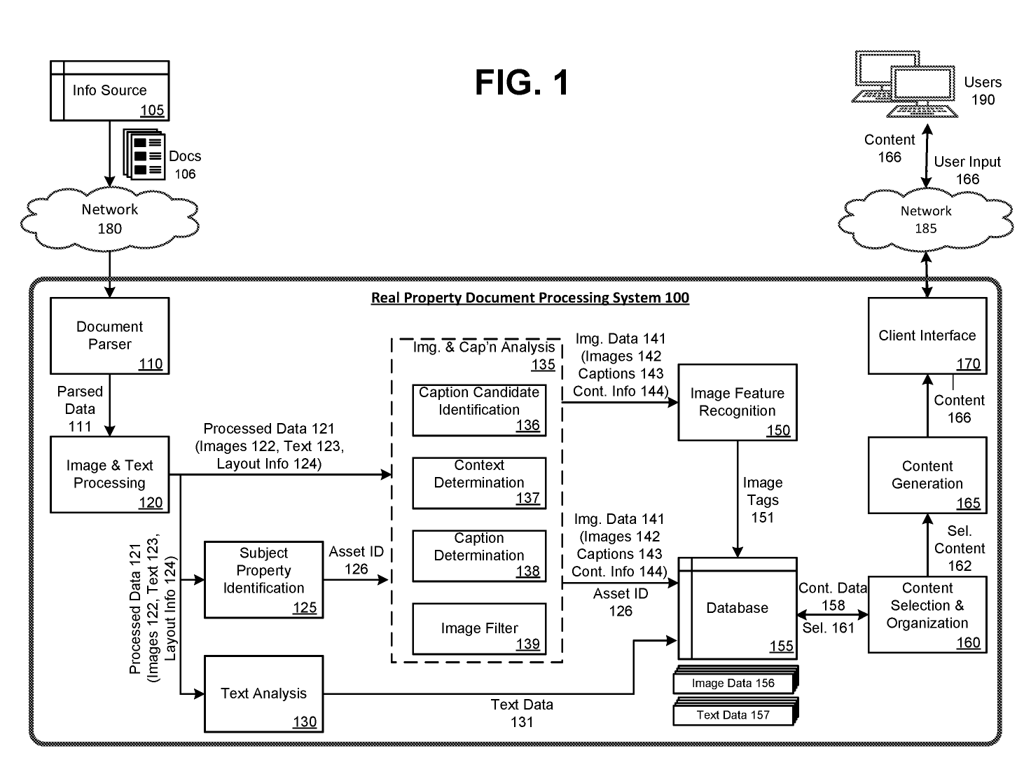

FIG. 1 is a block diagram illustrating an example real property document processing system (RPDPS) for extracting and analyzing images and other information from real property documents, in accordance with examples described herein. The RPDPS 100 can receive real property documents from various sources, extract information (e.g., images and other information) from the documents, and process and analyze the extracted information. Based on the processing and analysis of the extracted information, the RPDPS 100 can programmatically generate content (e.g., websites, webpages, and the like) pertaining to real property assets for display to users (e.g., potential buyers of real property assets) of the RPDPS 100. The RPDPS 100 includes document parser 110, image and text processing 120, subject property identification 125, text analysis 130, image and caption analysis 135, image feature recognition 150, database 155, content selection and organization 160, content generation 165, and client interface 170.

The RPDPS 100 receives real property documents 106 from information source 105 over a network 180. The network 180 can be the Internet. In other examples, the network 180 can be a local area network (LAN) that resides behind a corporate firewall. The information source 105 can be one or more publicly available databases storing real property documents pertaining to real property assets. The information source 105 can also be one or more subscription-based or privately-accessible databases (e.g., subscription-based appraisal database).

The real property documents 106 can be received in electronic format. Examples of various supported electronic formats include Portable Document Format (PDF), Hypertext Markup Language (HTML), Microsoft Word, WordPerfect, etc. Certain embodiments provide for the use of documents 106 in physical (e.g. hardcopy) format. In these and other embodiments, the system or an operator (e.g. system administrator) can convert the real property documents 106 into electronic format (e.g., in PDF format) by automatically or manually scanning the hardcopy documents so that could be processed by the RPDPS 100. Examples of real property documents can include appraisal documents, real property loan documents, broker price opinion documents, photograph addendums, inspection reports, lien documents, title search reports, etc. Real property documents 106 generally pertain to a subject property. For example, an appraisal document can pertain to a subject property being appraised (e.g., property whose value is being sought). As another example, a loan document can relate to a subject property for which a loan is being sought or processed. Real property documents 106 can also include information for one or more other properties (e.g., comparable properties). For instance, an appraisal document can also include information corresponding to one or more comparable properties, which are properties with characteristics that are similar to the subject property. Information contained in real property documents 106 can include a broad range of information corresponding to the subject property and/or comparable properties. For instance, an appraisal document can include the following information for the subject property and/or comparable properties: address, size (e.g., square footage or number of rooms), features (e.g., appliances, finish, upgrades etc.), neighborhood information (e.g. information regarding schools, parks, shopping areas, or other amenities), etc.

The document parser 110 receives the real property documents 106 and extracts pieces of information (e.g., images, text, and other information) from the real property documents 106. The parsed data 111 is transmitted to image and text processing. According to embodiments, the document parser 110 can be configured to recognize portions of the real property documents 106 that contain images and crop these portions of the real property documents 106 for extraction. For instance, the document parser 110 can be configured to distinguish portions of real property documents 106 that contain images from other portions that contain textual information or white space. In some instances, image data are embedded as separate data structures within the real property documents 106 (e.g. PDF files), and the document parser 110 can be configured to recognize such data structures and retrieve the image data structures as part of the parsing process. In some examples, the document parser recognizes text through techniques such as OCR to extract text from the real property documents 106. The document parser 110 can also extract renderable text from the documents 106 (e.g., text in electronic format embedded in the documents).

In certain implementations, the document parser 110 can extract layout information for analysis by the RPDPS 100. Layout information can include the positions and/or orientations of various extracted features (e.g., image, text, etc.) as they appear on the real property document 106. Furthermore, in addition to extracting textual information, the document parser 110 can also extract text formatting information such as font style, size, color, highlighting, emphases (e.g., bolding, italics, or underlining), etc. In this manner, such formatting information can be used by other components of the RPDPS 100 to process the textual information extracted from the real property documents 106. The extracted layout and formatting information can be part of the parsed data 111.

In various aspects, the document parser can further extract information such as metadata and identification of the information source 105. Metadata can include information attached to the real property document that may not be visible on the face of the document such as file size, date of document creation, date of document modification, author, comments, track change information, tags, and the like. Identification of the information source 105 can allow the RPDPS to use rules or parameters specific to documents stored by the particular information source 105 in analyzing the parsed data 111. For instance, real property documents 106 from a particular information source 105 can be in a multi-column format, and the first column pertains to the subject property. Accordingly, the identification of the information source 105 can allow components (e.g., subject property identification 125) to more easily identify the subject property in such real property documents 106, for example.

The image and text processing 120 receives the parsed data 111 and processes the received data and information to generate processed data 121. The processed data 121 can include processed images 122, processed text 123, and processed layout information 124. The processed data 121 can also include additional information or data such as formatting information extracted from the real property documents 106. In certain implementations, the image and text processing can process extracted images to generate processed images 122. The image and text processing 120 by applying one or more correction or compensation techniques to improve the images' quality or to correct for defects. For instance, the image and text processing 120 can crop images to reduce wasted space (e.g., white space) or irrelevant portions. The image and text processing 120 can crop images such that the most relevant portions of the image (e.g., portions depicting the subject property or comparable properties) are retained and centered. The image and text processing 120 can also resize images to enlarge or reduce them to suitable sizes. The image and text processing 120 can also rotate images (e.g., leveling) such that features or objects depicted therein are oriented at a certain angle (e.g., 90 or 180 degrees) with respect to the borders of the images. According to embodiments, the image and text processing 120 can apply post-processing techniques such as adjusting the focus, color palette, contrast, or tones of the images. The image and text processing 120 can perform touchup operations to clean up the images. In some embodiments, the image and text processing 120 can also recognize text that appears in the extracted images using, for example, OCR techniques.

In some examples, the image and text processing 120 also processes extracted text to generate, for example, processed text 123. In generating the processed text 123, the image and text processing 120 can detect and correct for spelling and grammar errors or inconsistencies. It can also detect portions of the extracted text that are in a language different from a default language (e.g., English) and translate those portions into the default language. In some examples, the image and text processing 120 can recognize that certain disparate portions of the extracted text 113 should be joined together and reorganizes the structure of the text such that the text flows logically. For instance, extracted text may contain disjointed textual information (e.g., a portion of text interjected by another unrelated portion of text) because of formatting or layout issues in the received real property document 106. The image and text processing 120 can examine the extracted text and determine the disjointed portions of text within the extracted text, and reorganize the textual information such that the text flows logically in the processed text 123.

The subject property identification 125 receives the processed data 121, including one or more of its subcomponents (e.g., processed images 122, processed text 123, and layout information 124). For each real property document 106, the property identification 115 analyzes the processed data 121 to identify a respective subject property. The subject property identification 125 can output the identification of the subject property as Asset ID 126. In various aspects, the Asset ID 126 can be an address, a listing number (e.g., MLS listing number), or another identifier (e.g., a proprietary or private identifier). The identification of the subject property can be based on analysis of processed text 123. For instance, the subject property identification 125 can parse the processed text 123 for keywords or phrases (e.g., “Appraisal of,” “Subject,” “MLS No.,” “Address,” “Property Location,” etc.) to identify portions of the processed text 123 that are likely or unlikely to contain identification information regarding the subject property. In certain implementations, the subject property identification 125 can be configured to retrieve additional identification information regarding the subject property using information determined in the parsed data 121. For instance, upon identifying the subject property by its address listed in the source document (e.g., by parsing processing text 123), the subject property identification 125 is configured to retrieve additional information (e.g., MLS listing number etc.) regarding the subject property by querying a database (e.g., MLS listing database).

The text analysis 130 receives processed data 121, including at least the processed text 123 to generate text data 131, which can be used by the RPDPS 100 in generating content pertaining to the subject property. The text analysis 130 can identify key portions of text to include in generating content 166, such as description of the subject property's condition, location, neighborhood, architectural style, etc.

According to embodiments, the image and caption analysis 135 receives processed data 121, including one or more of its subcomponents (e.g., processed images 122, processed text 123, and layout information 124). The image and caption analysis 135 analyzes the processed data 121 to associate portions of processed text 123 extracted from the real property document 106 as captions to images 122 extracted from the real property document 106. The image and caption analysis 135 outputs image data 141 that includes the images 142, the images' associated captions 143, and context information 144.

Image and caption analysis 135 includes caption candidate identification 136, context determination 137, caption determination 138, and image filter 139. The caption candidate identification 136 determines, for each extracted image, one or more portions of text as caption candidates. The caption candidates can be identified based on their respective positions relative to the images. For instance, caption candidate identification 136 can identify portions of text that are depicted in close proximity to an image as caption candidates for that image. The context determination 137 determines one or more contexts for each processed image 122. According to embodiments, available contexts for images include “Interior” (e.g., indicating that the image depicts an interior portion of a real property asset) and “Exterior” (e.g., indicating that the image depicts an exterior portion of a real property asset). In other implementations, RPDPS 100 can also determine contexts representing a specific portion of a real property depicted in the image, such as “Front Yard,” “Living Room, “Garage,” and the like. Caption determination 138 can determine, for each processed image 122, an appropriate one of the caption candidates as the image's caption. The determination of an appropriate caption candidate can be based on the relative positions of the image and the caption candidates. The determination can also be based on the determined context of the images and matching text from the caption candidates to known keywords associated with the determined context. In certain implementations, image filter 139 removes or discards processed images 122 that do not pertain to the identified subject property. The discarding of such images reduces the amount of processing the RPDPS 100 must perform in analyzing the real property documents 106. Furthermore, discarding processed images 122 that do not pertain to the identified subject property ensures that images unrelated to the subject property are not analyzed to determine characteristics of the subject property. In this manner, accuracy of the analyses and results of the RPDPS 100 is improved.

The image feature recognition 150 identifies real property features depicted in the images 142 and outputs one or more image tags 151 corresponding to the images 142. The image feature recognition 150 can identify real property features based on information parsed from the images' associated captions 143. Furthermore, the image feature recognition 150 can identify features based on context information 144 associated with the images 142. For instance, image feature recognition 150 can perform specific and tailored identification of real property features for an image based on the image's context information. As one example, image feature recognition can use parameters and reference databases specific to identifying features in a kitchen (e.g., stainless steel appliances, gas range, etc.) for an image with a context of “Kitchen.”

According to embodiments, the database 155 receives and stores image data 141, including one or more of its subcomponents (e.g. images 142, image captions 143, and context information 144) as image data 156. The image data 156 can be organized by the Asset ID 126 such that the database can readily query and identify image data corresponding to a particular real property asset. The image data 156 can also include image tags 151 generated by the image feature recognition 150. Additionally, the database can receive text data 131 from text analysis 130 and store such information as text data 157. The data stored in the database, including image data 156 and text data 157, can be used by the RPDPS 100 to generate content pertaining to real property assets (e.g., webpages, interactive content, videos, etc.). In certain implementations, the RPDPS 100 can also communicate with a content generation system which generates the content.

The content selection and organization 160 can query the database 155 (e.g., by a selection 161 input to the database 155) to retrieve content data 158 from the database 155. Content data 158 can include image data 156, text data 157, or any subcomponents thereof. For instance, the content selection and organization 160 can query the database 155 by an Asset ID. The content selection and organization 160 can also specify the types of data required from the database (e.g., image data, text data, or both). The content selection and organization 160 can select and organize images using, for example, tags and contexts for the images. For instance, the content selection and organization 160 can determine a particular sequence of images to present within the generated content based on contexts associated with the images (e.g., Exterior images first then Interior images, Living Room images before Bathroom images). The content selection and organization 160 can also select images based on their tags. For instance, an image without any identified tags may be ignored by the content selection and organization in favor of other images with associated tags. In various aspects, the content selection and organization 160 can also select images based, at least in part, on one or more determined characteristics of the subject property. For a subject property determined to be a residential property (e.g., based on Asset ID or listing number), content selection and organization 160 can determine to select at least one image having a “Kitchen” context for use in generating content. For a subject property determined to be an office space, content selection and organization 160 can determine to select at least one image having a “Lobby” or “Office Space” context for use in generating content.

The content generation 165 receives selected content 162 from content selection and organization 160 to generate content 166 pertaining to the subject property. Content 166 can be a web page or website presented to users 190 of the RPDPS 100 (e.g., potential buyers or bidders of real property assets). Content 166 can be an auction page for auctioning the subject property in an online auction forum or a listing page for a traditional real property transaction. According to embodiments, the generated content 166 can be searchable using tags or contexts associated with images selected for display within the content 166. Thus, users can easily query specific features that are depicted in the images displayed within the content 166. For instance, a user can query for all content that includes one or more images that include a “White Picket Fence” tag. Accordingly, users are able to query for desirable or undesirable real property features depicted in the images in searching through real property listing or auction pages. As another example, while viewing content pertaining to a specific property, the user can query for all images having a “Kitchen” context.

The client device interface 170 receives the generated content 166. The client device interface 170 manages connections and requests from users 190 over a network 185 (e.g., the Internet) to transmit data pertaining to the content 166 over the network to computing devices operated by the users 190 for display.

Methodology

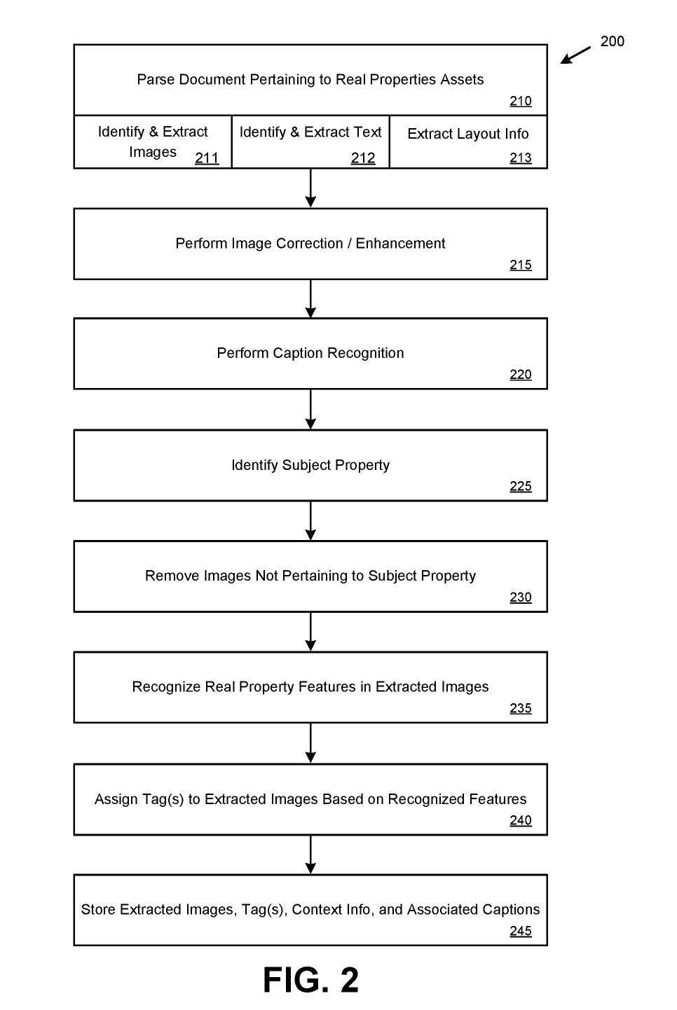

FIG. 2 is a flow chart describing an example method for parsing real property documents, according to examples described herein. In the below discussion of FIG. 2, reference may be made to features and examples shown and described with respect to FIG. 1. Furthermore, the process described with respect to FIG. 2 may be performed by an example real document processing system such as the one as shown and described with respect to FIG. 1.

Referring to FIG. 2, RPDPS 100 parses a document pertaining to real property assets to extract various features depicted in the document (210). The document can be an appraisal document, a loan document, a broker price opinion document, a photograph addendum, an inspection report, a lien document, a title search report, etc. The RPDPS 100 can receive the document from a depository or an information source over a network such as the Internet. To parse the document, the RPDPS 100 can perform text recognition (e.g., optical character recognition) and image recognition techniques. As part of parsing the document 210, the RPDPS 100 can identify and extract images depicted in the document (211). The RPDPS 100 can also identify and extract text in the document (212). Furthermore, the RPDPS 100 can extract layout information (213). Extracted layout information can include information regarding the positions and orientations of the extracted features. According to embodiments, the RPDPS 100 can also extract metadata information from the document for use in processing the extracted features. Metadata information can be information attached to the document that may not be visible on the face of the document. Metadata information can include file size, date of document creation, date of document modification, author, comments, track change information, tags, and the like. The extracted images, text, layout information, and metadata information can be cached by the RPDPS 100 for processing. In certain implementations, the RPDPS 100 can store the extracted features and information in one or more databases (e.g., database 155 of FIG. 1).

The RPDPS 100 can perform image correction and/or image enhancement (215). Image correction and enhancement techniques performed at this stage can include modifying the contrast, exposure, saturation, color palette, or other techniques to improve the viewability and clarity of the extracted images. The RPDPS 100 can also resize the images (e.g., modify the resolution of images) at this step to reduce the size of images that are too large for example. The RPDPS 100 can also crop images that include extraneous empty space.

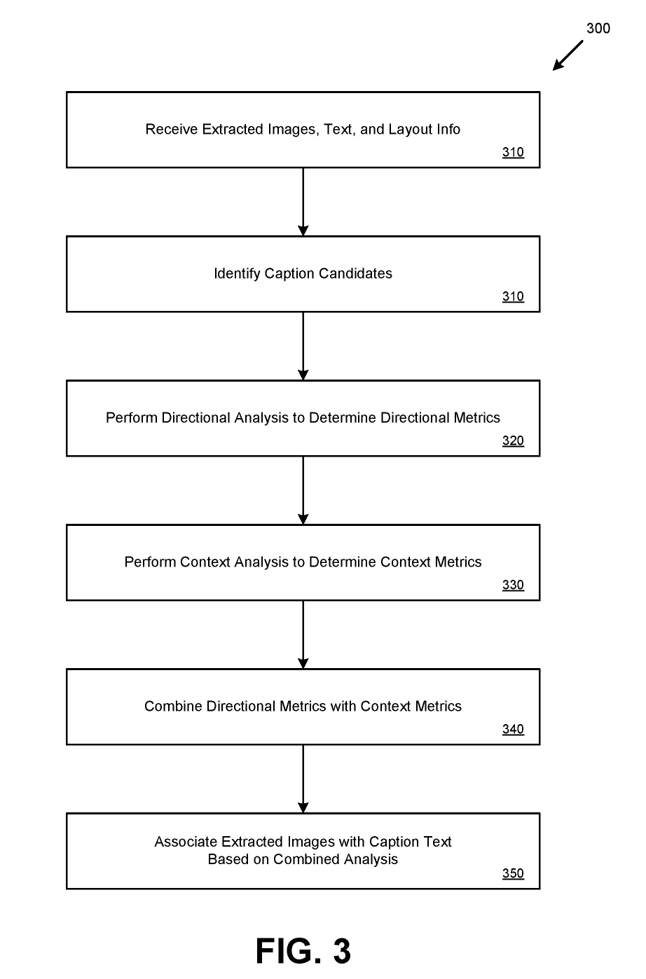

The RPDPS 100 can perform caption recognition using the extracted images that are corrected and/or enhanced (220). Caption recognition can include identifying portions of text extracted from the real property document (e.g., identified and extracted in step 212) for each of the extracted images. For each extracted image, the RPDPS 100 can then determine an appropriate one of the caption candidates as the associated caption. Determination of an appropriate one of the caption candidates can be achieved by conducting directional analysis. Such a determination can also be achieved by performing context analysis. The RPDPS 100 can also combine the results of directional analysis and context analysis to determine an appropriate one of the caption candidates as the image caption. An example caption recognition method is illustrated and described by FIG. 3.

The RPDPS 100 can identify the subject property of the document (225). The subject property can be identified based on analysis of text extracted from the real property document. For instance, the RPDPS 100 can parse the extracted text for keywords or phrases (e.g., “Appraisal of,” “Subject,” “MLS No.,” “Address,” “Property Location,” etc.) to identify portions of the extracted text that are likely or unlikely to contain identification information regarding the subject property. The subject property can be identified using an address, a listing number, or another unique identifier that enables the RPDPS 100 to identify the subject property.

The RPDPS 100 can remove images not pertaining to the subject property that do not pertain to the subject property (230). This step can be performed by parsing information in the captions associated with the extracted images at step 220. For instance, information in a caption of the image can indicate that the image depicts a comparable property rather than the subject property.

RPDPS 100 can recognize real property features in extracted images (235) by analyzing the images, their associated captions, and their context information. By analyzing such information, the RPDPS 100 can identify real property features such as an attached garage, a Spanish-style roof, a white picket fence, a kitchen with an island, and the like. In various implementations, the RPDPS 100 can perform the real property feature recognition for an image based on the determined context of the image. For instance, an image having a determined context of “Interior” can be analyzed for real property features differently (e.g., based on a different set of criterion or using a different comparison database) than another image having a determined context of “Exterior.” Thus, the determination of real property features depicted in an image can be tailored based on the determined context of the image. In another example, real property feature identification for an image can be made specific to a context that corresponds to a portion of the real property asset depicted in the image (e.g., a “Kitchen” context). Thus, parameters and a comparison database specific for identifying real property features in a kitchen (e.g., gas range, stainless steel appliances, etc.) can be used to in identifying real property features for an image with a “Kitchen” context. The RPDPS 100 can assign one or more tags to extracted images based on the recognized features (240). For example the RPDPS 100 can assign a tag of “Stainless Steel Appliances” to an image that is recognized as depicting stainless steel appliances.

RPDPS 100 can store the extracted images and associated information such as captions, context information, and tags in a database (e.g., database 155 of FIG. 1). The extracted images and associated information can be used to generate content (e.g., webpages, websites, videos, or interactive content) pertaining to the identified subject property. In this manner, the RPDPS 100 can collect images and other information extracted from a plurality of real property documents that pertain to the subject property to generate content pertaining to that subject property. In some embodiments, the generated content can be searched using tags such that users can search real property assets by identified real property features (e.g., Stainless Steel Appliances, White Picket Fence).

In certain implementations, in generating the content pertaining to the subject property, the RPDPS 100 can determine a property condition score pertaining to the subject property by analyzing the images, their associated captions, and other text extracted from the real property documents analyzed by the RPDPS 100. For instance, if text extracted from a real property document or captions associated with extracted images include keywords such as “mold,” “damage” “termite,” the RPDPS 100 can determine a low property condition score for the subject property. As another example, the RPDPS 100 can analyze images for signs of damage depicted in the images to determine the property condition score.

FIG. 3 is a flow chart describing an example method of associating extracted images with caption text, in accordance with examples described herein. In the below discussion of FIG. 3, reference may be made to features and examples shown and described with respect to FIG. 1. Furthermore, the process described with respect to FIG. 3 may be performed by an example RPDPS 100 as shown and described with respect to FIG. 1. For instance, the method described below in reference to FIG. 3 may be performed by one or more modules, components, or engines of the RPDPS 100, such as the image and caption analysis 135.

According to embodiments, the image and caption analysis 135 receives images, text, and layout information extracted from a real property document (310). Subsequently, the image and caption analysis 135 identifies portions of extracted text as caption candidates for each of the extracted images (315). The caption candidates can be identified based on their relative positions to the extracted images. For instance, a portion of text can be identified as a caption candidate for an image if the portion of text is in close proximity or immediately adjacent to the image. The image and caption analysis 135 can determine the relative positions of the extracted images and text using layout information, which can indicate the position of a feature (e.g., image or text) in the real property document (e.g., using a coordinate system).

The image and caption analysis 135 can perform directional analysis to determine directional metrics (320). The directional metrics can be used to associate the images with appropriate ones of the identified caption candidates. Directional analysis can be performed on a per-page or a per-document basis. A resulting directional metric can indicate a weight to attribute to a particular direction (e.g., up, down, right, or left) in associating images with their respective caption candidates on a particular page of a real property document.

The image and caption analysis 135 can perform context analysis to determine context metrics (330). For this step, one or more contexts can be determined for each extracted image. In some implementations, available contexts for images include “Interior” (e.g., indicating that the image depicts an interior portion of a real property asset) and “Exterior” (e.g., indicating that the image depicts an exterior portion of a real property asset). In other implementations, RPDPS 100 can also determine contexts representing a specific portion of a real property depicted in the image, such as “Front Yard,” “Living Room, “Garage,” and the like. Context determination can be performed by recognizing image features from the images and compared to a database of known image features for each available context. For instance, if the RPDPS 100 recognizes an oval shape in an image, the RPDPS can compare the oval shape to known features such as bathroom sinks, to determine that the image's context should be “Bathroom” or “Interior.” RPDPS 100 can also determine contexts by extracting colors to obtain a color palette or palette histogram of each image and comparing the extracted color compositions to a database of known color compositions. For instance, examining a color composition of an image that includes a high concentration of the color green, the RPDPS 100 can determine that a particular image depicts the outside of a real property asset. As an additional example, the RPDPS 100 can utilize metadata information such as a date of an image in the context determination. For instance, if metadata of an image indicates that the image was taken in the Summer, a high concentration of the color green can be considered as an indication that the image depicts an exterior of the real property asset.

After determining one or more context for an extracted image, the RPDPS 100 can determine directional metrics by comparing the text of each caption candidate against known keywords associated with the determined context(s) to determine whether each caption candidate is the appropriate caption for the image. For instance, the “Interior” context can have known keywords such as “high ceiling,” “walk-in closet,” and the like. The directional metric can be determined based on a number of hits of caption candidate text against such known keywords. In some embodiments, the directional metrics can also be determined based on a number of hits of negative keywords associated with a context. For instance, the “Interior” context can have negative keywords such as “front yard.” Thus, if a caption candidate has text that matches one or more negative keywords, the context metric for the caption candidate can be decreased.

The RPDPS 100 can combine the results of directional analysis (e.g., directional metrics) with the results of context analysis (e.g., context metrics) (340) to arrive at a combined metric that can be used to determine the appropriate caption candidates to associate with images as the images' respective captions. As an example, context metrics of caption candidates depicted below their respective images can be low or below a certain criterion, indicating a lack of matches of known keywords. In response, the RPDPS 100 can determine that a direction metric on the page corresponding to the direction “down” should be decreased in arriving at the combined metric. Subsequently, the RPDPS 100 can associate images with appropriate caption candidates based on the combined metrics (350). In this manner, the analyses of the RPDPS 100 can be based on a plurality of analytical models to settle on a result with the highest accuracy probability, making the outputs of the RPDPS 100 more robust in the presence of errors and inaccuracies in its inputs.

Example Real Property Document Layout

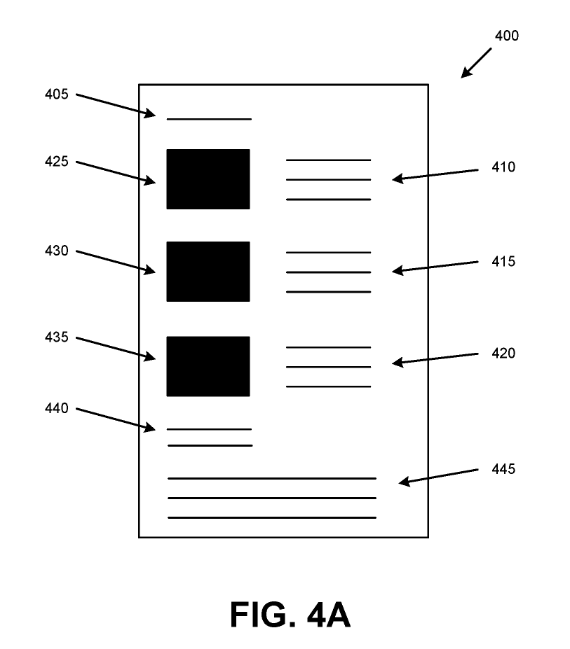

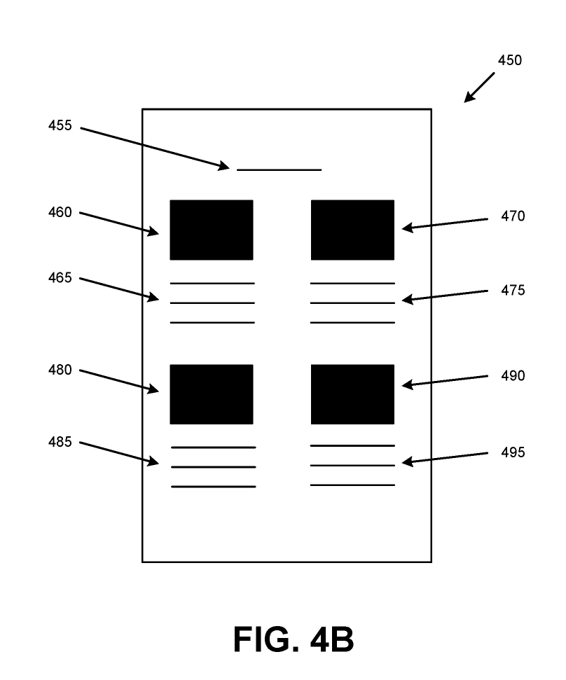

FIGS. 4A and 4B are figures illustrating layouts of sample real property documents that can be parsed and analyzed by an example real property document processing system, in accordance with examples described herein. In the below discussion of FIGS. 4A and 4B, reference may be made to features and examples shown and described with respect to FIG. 1. For instance, the real property document 400 can depict a layout of the real property document 106 of FIG. 1.

Referring to FIG. 4A, real property document 400 includes a plurality of portions of text 405, 410, 415, 420, 440, 445. The real property document 400 also includes a plurality of images 425, 430, 435. The RPDPS 100 can parse real property document 400 to extract each of the images 425, 430, 435, and each of the plurality of portions of text 405, 410, 415, 420, 440, 445. The RPDPS 100 can also extract layout information regarding the position of each of the extracted features on a page of the real property document. Based on the extracted layout information, the RPDPS 100 can identify some of the plurality of portions of text as caption candidates for each of the extracted images 425, 430, 435 based on their relative positions (e.g., immediately adjacent to the image, based on a distance criterion). The criteria for determining caption candidates can be pre-determined (e.g., a pre-determined distance criterion) or may be dynamically determined (e.g., a dynamically determined distance criterion) based on the layout information. For instance, for image 425, the RPDPS 100 can identify portions of text 405 and 410 as caption candidates because they are immediately adjacent and/or within a certain distance to image 425. For image 430, the RPDPS 100 can identify text 415 as a caption candidate. Similarly, for image 435, the RPDPS 100 can identify text 420 as a caption candidate. Text 445 may not be identified as a caption candidate for any of the images 425, 430, and 435 because it is not immediately adjacent to any of the images and it is not within a distance criterion of any of the images 425, 430, 435. According to embodiments, the RPDPS 100 can also identify a portion of text as a caption candidate for an image if the RPDPS 100 determines that the portion of text is the closest portion of text to the image in a particular direction (e.g., up, down, right, or left) from the image. The RPDPS 100 can also determine directional metrics for the real property document 400. For instance, it can determine that the highest directional metric pertaining to the page of the real property document 400 corresponds to the direction “RIGHT” because of a number of caption candidates being depicted to the right of their respective images within the real property document 400.

Referring to FIG. 4B, real property document 450 includes a plurality of portions of text 455, 465, 475, 485, 495. The real property document 450 also includes a plurality of images 460, 470, 480, 490. The RPDPS 100 can parse real property document 450 to extract each of the images 460, 470, 480, 490, and each of the plurality of portions of text 455, 465, 475, 485, 495. The RPDPS 100 can also extract layout information regarding the position of each of the extracted features on a page of the real property document. Based on the extracted layout information, the RPDPS 100 can identify some of the plurality of portions of text as caption candidates for each of the extracted images 460, 470, 480, 490 based on their relative positions. For instance, for image 460, the RPDPS 100 can identify portions of text 455 and 465 as caption candidates because they are immediately adjacent and/or within a certain distance to image 460. For image 480, the RPDPS 100 can identify text 485 as a caption candidate. The RPDPS 100 can also determine directional metrics for the real property document 450. For instance, it can determine that the highest directional metric pertaining to the page of the real property document 450 corresponds to the direction “DOWN” because of a number of caption candidates being depicted below their respective images within real property document 450.

Hardware Diagram

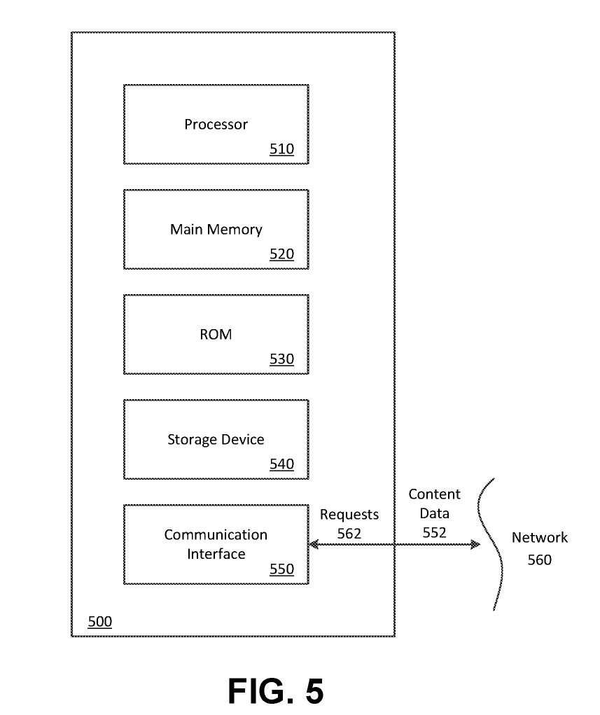

FIG. 5 is a block diagram illustrating a computer system upon which examples described herein may be implemented. A computer system 500 can be implemented on, for example, a server or combination of servers. In one implementation, the computer system 500 includes processing resources 510, a main memory 520, a read-only memory (ROM) 530, a storage device 540, and a communication interface 550. The computer system 500 includes one or more processors 510 for processing information stored in the main memory 520, such as provided by a random access memory (RAM) or other dynamic storage device, for storing information and instructions which are executable by the processor 510. The main memory 520 also may be used for storing temporary variables or other intermediate information during execution of instructions to be executed by the processor 510. The computer system 500 may also include the ROM 530 or other static storage device for storing static information and instructions for the processor 510. A storage device 540, such as a magnetic disk or optical disk, is provided for storing information and instructions.

The communication interface 550 enables the computer system 500 to communicate with one or more networks 560 (e.g., the Internet) through use of the network link (wireless or wired). Using the network link, the computer system 500 can communicate with one or more computing devices operated by, for example, potential buyers of real property assets. The computer system can receive requests 562 to display content pertaining to real property assets. In response, the computer system 500 can transmit content data 552.

By way of example, the instructions and data stored in the memory 520 can be executed by the processor 510 to implement an example real property document processing system 100 of FIG. 1. The processor 510 is configured with software and/or other logic to perform one or more processes, steps and other functions described with implementations, such as described by FIGS. 2 to 3, and elsewhere in the present application.

Examples described herein are related to the use of the computer system 500 for implementing the techniques described herein. According to one example, those techniques are performed by the computer system 500 in response to the processor 510 executing one or more sequences of one or more instructions contained in the main memory 520. Such instructions may be read into the main memory 520 from another machine-readable medium, such as the storage device 540. Execution of the sequences of instructions contained in the main memory 520 causes the processor 510 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the examples are not limited to those precise descriptions and illustrations. As such, many modifications and variations will be apparent to practitioners. Accordingly, it is contemplated that a particular feature described either individually or as part of an example can be combined with other individually described features, or parts of other examples, even if the other features and examples make no mentioned of the particular feature.

What is claimed is:

1. A real property document processing system comprising:
one or more processors; and
one or more memory resources storing instructions that, when executed by the one or more processors, cause the one or more processors to:
receive a real property document pertaining to a subject property, the real property document depicting a plurality of images and a plurality of portions of text;
parse the real property document to extract the plurality of images and the plurality of portions of text;
perform caption association to associate at least one image of the plurality of images with at least one portion of text from the plurality of portions of text as a corresponding caption; and
analyze the at least one image and the corresponding caption to associate one or more tags to the at least one image, the one or more tags each being indicative of a characteristic pertaining to the subject property.

2. The real property document processing system of claim 1, wherein the executed instructions further cause the processors to:
identify, on a page of the real property document depicting the at least one image, one or more portions of text as caption candidates for the at least one image, each of the caption candidates being identified based on its proximity on the page to the at least one image; and
select one of the caption candidates as the corresponding caption.

3. The real property document processing system of claim 2, wherein the executed instructions further cause the processors to select one of the caption candidates based on a first metric computed based on (i) a position of the at least one image in relation each of the caption candidates and (ii) a position of a second image depicted on the page in relation to each of the second image's caption candidates.

4. The real property document processing system of claim 2, wherein the executed instructions further cause the processors to determine a context for the at least one image.

5. The real property document processing system of claim 4, wherein the executed instructions further cause the processors to select one of the caption candidates based on a second metric computed based on a comparison between text in each of the caption candidates and a set of predetermined keywords associated with the determined context.

6. The real property document processing system of claim 4, wherein the determined context is one of (i) an interior context; and (ii) an exterior context.

7. The real property document processing system of claim 4, wherein the determined context is indicative of a portion of a real property depicted in the at least one image.

8. The real property document processing system of claim 1, wherein the executed instructions further cause the processors to identify a subject property of the real property document.

9. The real property document processing system of claim 7, wherein the executed instructions further cause the processors to discard images of the plurality of images that do not pertain to the subject property.

10. The real property document processing system of claim 1, wherein the executed instructions further cause the processors to generate content using the at least one image and the corresponding caption.

11. The real property document processing system of claim 10, wherein the content is searchable using the one or more tags.

12. The real property document processing system of claim 1, wherein the executed instructions further cause the processors to extract metadata information from the real property document.

13. The real property document processing system of claim 1, wherein the executed instructions further cause the processors to determine a property condition score based on the at least one image and the associated caption.

14. The real property document processing system of claim 1, wherein the executed instructions further cause the processors to determine a property condition score based on the one or more tags.

15. A computer-implemented method of analyzing a real property document, the method being performed by one or more processors and comprising:
receiving the real property document pertaining to a subject property, the real property document depicting a plurality of images and a plurality of portions of text;
parsing the real property document to extract the plurality of images and the plurality of portions of text;
performing caption association to associate at least one image of the plurality of images with at least one portion of text from the plurality of portions of text as a corresponding caption; and
analyzing the at least one image and the corresponding caption to associate one or more tags to the at least one image, the one or more tags each being indicative of a characteristic pertaining to the subject property.

16. The method of claim 15, further comprising
identifying, on a page of the real property document depicting the at least one image, one or more portions of text as caption candidates for the at least one image, each of the caption candidates being identified based on its proximity on the page to the at least one image; and
selecting one of the caption candidates as the corresponding caption.

17. The method of claim 16, further comprising selecting one of the caption candidates based on a first metric computed based on (i) a position of the at least one image in relation each of the caption candidates and (ii) a position of a second image depicted on the page in relation to each of the second image's caption candidates.

18. The method of claim 16, further comprising determining a context for the at least one image.

19. The method of claim 18, further comprising selecting one of the caption candidates based on a second metric computed based on a comparison between text in each of the caption candidates and a set of predetermined keywords associated with the determined context.

20. A non-transitory computer-readable medium storing instructions that, when executed by one or more processors, cause the one or more processors to:
receive a real property document pertaining to a subject property, the real property document depicting a plurality of images and a plurality of portions of text;
parse the real property document to extract the plurality of images and the plurality of portions of text;
perform caption association to associate at least one image of the plurality of images with at least one portion of text from the plurality of portions of text as a corresponding caption; and
analyze the at least one image and the corresponding caption to associate one or more tags to the at least one image, the one or more tags each being indicative of a characteristic pertaining to the subject property.
